(19) United States
(12) Patent Application Publication
(10) Pub. No.: US 2016/0107863 A1
(43) Pub. Date: Apr. 21, 2016

(54) ELEVATOR MOTOR COOLING ASSEMBLY

(71) Applicant: OTIS ELEVATOR COMPANY, Farmington, CT (US)

(72) Inventor: Zlatko Strbuncelj, Avon, CT (US)

(21) Appl. No.: 14/893,107

(22) PCT Filed: May 28, 2013
(86) PCT No.: PCT/US2013/042868

§ 371 Date: Nov. 23, 2015

(51) Int. Cl. B66B 11/04; H02K 9/04

(52) U.S. Cl. CPC B66B 11/043; H02K 9/04

(57) ABSTRACT

An elevator motor assembly includes a motor for driving an elevator, a temperature sensor for detecting a temperature of the motor and a blower configured to blow air onto the motor to cool the motor, and configured to blow air at varying speeds that vary according to a temperature detected by the temperature sensor.

### BACKGROUND OF THE INVENTION

The subject matter disclosed herein relates to elevator motors, and in particular to a system for cooling an elevator motor with a variable-speed blower.

Conventional elevator cooling systems using forced ventilation run at full speed, resulting in significant noise and energy consumption.

### BRIEF DESCRIPTION OF THE INVENTION

According to one aspect of the invention, an elevator motor assembly includes a motor for driving an elevator, a temperature sensor for detecting a temperature of the motor and a blower configured to blow air onto the motor to cool the motor, and configured to blow air at varying speeds that vary according to a temperature detected by the temperature sensor.

According to another aspect of the invention, an elevator assembly includes an elevator carriage, an elevator motor configured to drive the elevator carriage, a temperature sensor configured to detect a temperature of the elevator motor, and a blower configured to blow air onto the motor to cool the motor, and configured to blow air at varying speeds that vary according to a temperature detected by the temperature sensor.

According to another aspect of the invention, a method of cooling an elevator motor includes detecting a temperature of the elevator motor and varying a speed of a blower that blows air onto the elevator motor based on detecting varying temperatures of the elevator motor.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates an elevator assembly according to an embodiment of the invention;

FIG. 2 illustrates a blower assembly according to one embodiment of the invention; and

FIG. 3 is a block diagram of a method of varying a blowing air onto a motor according to an embodiment of the invention.

The detailed description explains embodiments of the invention, together with advantages and features, by way of example with reference to the drawings.

### DETAILED DESCRIPTION OF THE INVENTION

Conventional elevator motor cooling systems that utilize forced ventilation remain on full speed when turned on, resulting in noise and in excessive energy usage. Embodiments of the invention relate to a system for adjusting the speed of a cooling blower based on the detected temperature of the elevator motor.

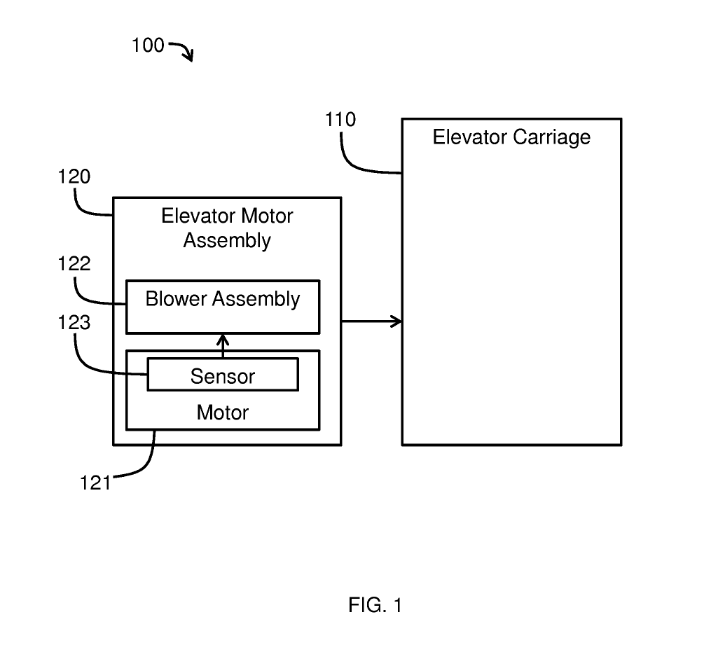

FIG. 1 illustrates an elevator system 100 according to an embodiment of the invention. The system 100 includes an elevator carriage 110 and an elevator motor assembly 120 that drives the carriage 110. The elevator motor assembly 120 includes a motor 121 and a blower 122 that blows air onto the motor 121 to cool the motor 121. Blower 122 may direct air onto an outside surface of motor 121 or blow air internal to motor 121, over windings of motor 121. In embodiments of the invention, a temperature sensor 123 is provided on, or in, the motor 121 to monitor temperature of the motor 121.

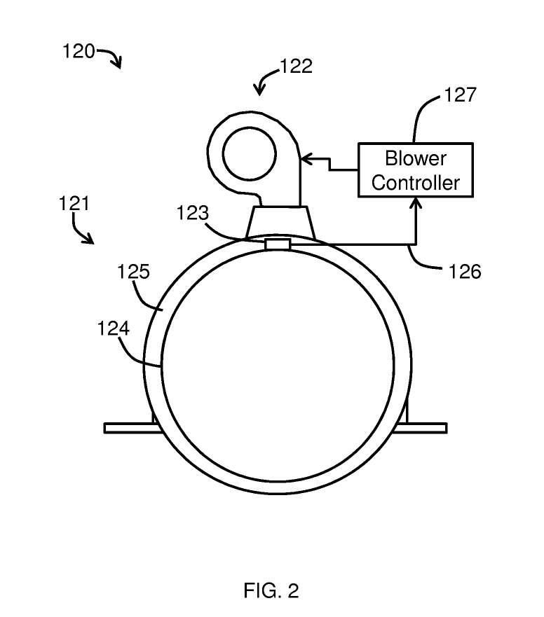

The elevator motor assembly 120 is illustrated in further detail in FIG. 2. The elevator motor assembly 120 includes the motor 121, the blower 122 and a blower controller 127. The sensor 123 is located on, or in, the motor 121 to detect a temperature of the motor 121. The sensor 123 outputs the sensed temperature to the blower controller 127 via the temperature feedback line 126, and the blower controller 127 adjusts a speed of the blower 122 according to the detected temperature. As a result, if the motor 121 is at a lower temperature, the blower speed may be reduced, which reduces a noise output from the blower 122 and an energy level consumed by the blower 122.

In one embodiment, the elevator mower includes a stator 125 that includes windings, and a rotor portion 124 that includes permanent magnets. The motor 121 may drive the elevator carriage 110 based on an electrical current being applied to the windings of the stator 125, which drives a shaft of the rotor portion 124. In one embodiment, the temperature sensor 123 is located on the stator 125, such as in the windings of the stator 125. Motor 121 may be a multiphase (e.g., three phase) motor, however, embodiments of the invention encompass any type of motor that drives an elevator.

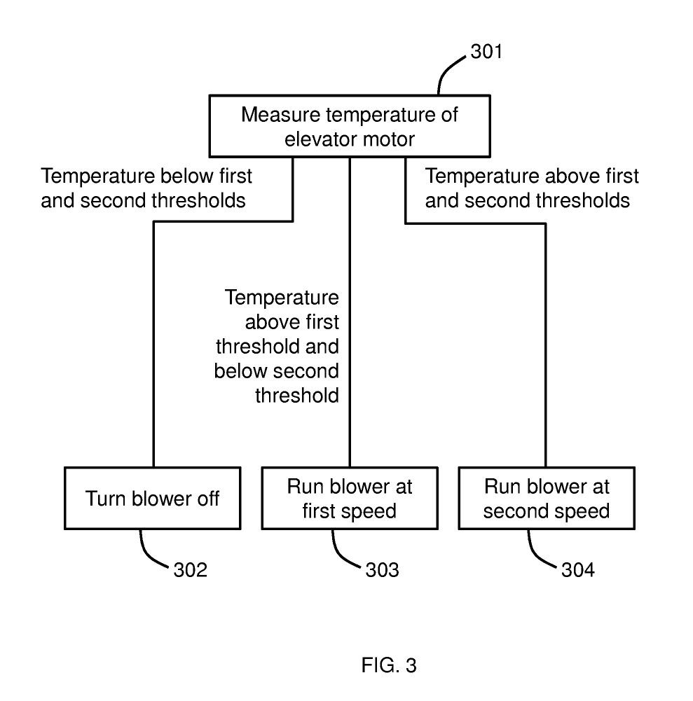

FIG. 3 illustrates a method of controlling the blower 122 based on the temperature detected by the temperature sensor 123. In block 301, the temperature of the motor is detected by the temperature sensor. The detected temperature is compared to one or more thresholds to adjust the speed of the blower 122. In FIG. 3, only two thresholds are illustrated. However, embodiments of the invention encompass any number of thresholds, from one threshold to a sufficient number of thresholds such that the variable speed of the blower 122 appears to be continuous between an off state and a full power state. In FIG. 3, if it is determined that the detected temperature is less than a first and second threshold, then the blower 122 may be turned off at block 302. In such a state, the elevator motor 121 may be off, or may be operating at a very low power level that does not result in substantial heating of the motor.

If it is determined that the detected temperature is greater than a first threshold but less than a second threshold, then the blower 122 may be operated at a first speed in block 303. The first speed may be a low speed that results in a relatively low noise level and relatively low power consumption. On the other hand, if it is determined that the detected temperature is greater than the first and second thresholds, then the blower 122 may be run at a second speed in block 304. The second speed may be a high speed, such as full speed, resulting in a relatively high noise level and relatively high power consumption level.

According to embodiments of the invention, a blower for cooling an elevator motor may be run at variable speeds according to a detected temperature of the motor. Accordingly, noise levels may be reduced and power consumption may be reduced by not operating the blower at full power all the time.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An elevator motor assembly, comprising:
a motor for driving an elevator;
a temperature sensor for detecting a temperature of the motor; and
a blower configured to blow air onto the motor to cool the motor, and configured to blow air at varying speeds that vary according to a temperature detected by the temperature sensor.

2. The elevator motor assembly according to claim 1, wherein the blower is configured to operate at two or more speeds corresponding to two or more threshold temperatures.

3. The elevator motor assembly of claim 1, wherein the blower is configured to blow air onto an outside surface of the motor.

4. The elevator motor assembly according to claim 1, wherein the motor includes windings and permanent magnets, and
the sensor is located in the windings of the motor.

5. The elevator motor assembly of claim 4, wherein the blower is configured to blow air onto the windings.

6. The elevator motor assembly of claim 1, further comprising:
a blower controller configured to receive a detected temperature from the temperature sensor and output a blower control signal based on the detected temperature.

7. The elevator motor assembly of claim 6, wherein the blower controller is configured to compare the sensed temperature to two or more threshold values to control the blower to operate at three or more speeds.

8. An elevator assembly, comprising:
an elevator carriage;
an elevator motor configured to drive the elevator carriage;
a temperature sensor configured to detect a temperature of the elevator motor; and
a blower configured to blow air onto the motor to cool the motor, and configured to blow air at varying speeds that vary according to a temperature detected by the temperature sensor.

9. The elevator assembly according to claim 8, wherein the blower is configured to operate at two or more speeds corresponding to two or more threshold temperatures.

10. The elevator motor assembly of claim 8, wherein the blower is configured to blow air onto an outside surface of the motor.

11. The elevator motor assembly according to claim 8, wherein the motor includes windings and permanent magnets, and
the sensor is located in the windings of the motor.

12. The elevator motor assembly of claim 11, wherein the blower is configured to blow air onto the windings.

13. The elevator motor assembly of claim 8, further comprising:
a blower controller configured to receive a detected temperature from the temperature sensor an output a blower control signal based on the detected temperature.

14. A method of cooling an elevator motor, comprising:
detecting a temperature of the elevator motor; and
varying a speed of a blower that blows air onto the elevator motor based on detecting varying temperatures of the elevator motor.

15. The method of claim 14, wherein varying the speed of the blower includes comparing the detected temperature to two or more threshold temperatures corresponding to different speeds of the blower and varying the speed of the blower based on the relationship between the detected temperature and the two or more threshold temperatures.

16. The method of claim 15, wherein the two or more threshold temperatures includes a first threshold temperature and a second threshold temperature, and
the method comprises:
turning off the blower if the detected temperature is less than the first threshold temperature;
running the blower at a first speed if the detected temperature is greater than the first threshold value and less than the second threshold value; and
running the blower at a second speed if the detected temperature is greater than the second threshold value.
